(19) United States
(12) Patent Application Publication
(10) Pub. No.: US 2023/0321906 A1
(43) Pub. Date: Oct. 12, 2023

(54) NOZZLE FOR PRODUCING EXTRUSION THREE-DIMENSIONAL PRINTED MATERIALS

(71) Applicant: Essentium IPCO, LLC, Pflugerville, TX (US)

(72) Inventors: Chad Eichele, Lake Forest, CA (US); William Jack MacNeish, III, Santa Ana, CA (US); Iris Gisey Euan Waldestrand, Puebla (MX); Yasushi Mizuno, Houston, TX (US)

(21) Appl. No.: 18/042,886

(22) PCT Filed: Aug. 27, 2021
(86) PCT No.: PCT/US21/47909

§ 371 Date: Feb. 24, 2023

Related U.S. Application Data
(60) Provisional application No. 63/072,556, filed on Aug. 31, 2020.

(51) Int. Cl. B29C 64/209; B33Y 30/00

(52) U.S. Cl. CPC B29C 64/209; B33Y 30/00; B29K 2995/0013; B29K 2905/12; B29K 2905/08

(57) ABSTRACT

A nozzle for producing material extrusion in a three-dimensional printer includes a shank including an internal flow passage, where the shank is constructed of a first material having a first thermal conductivity. The nozzle also includes a shank barrel mechanically coupled to the shank. The shank barrel is constructed of a second material having a second thermal conductivity. The first thermal conductivity of the first material is different from the second thermal conductivity of the second material to create a first heat break between the shank and the shank barrel, where the first heat break reduces heat transfer between the shank and the shank barrel.

### CROSS-REFERENCE TO RELATED APPLICATIONS

This application claims priority to U.S. Application No. 63/072,556 filed on Aug. 31, 2020.

### FIELD

The present disclosure relates to a nozzle design and methods to produce three-dimensional printed materials using extrusion additive manufacturing processes.

### BACKGROUND

The statements in this section merely provide background information related to the present disclosure and may or may not constitute prior art.

Material extrusion additive manufacturing (ME-AM) is employed by three-dimensional printers to produce parts of varied geometry and function. Three-dimensional printers use specialized nozzles to move a filament of a solid polymeric material or a non-polymeric material through a heating element to convert the solid material into a low viscosity liquid. Traditional three-dimensional printer nozzles are comprised of a barrel, a heat block, a heater cartridge, a temperature sensor, and a nozzle tip. The barrel is typically threaded into a cooling barrel having cooling fins, and a fan blows air over the fins to keep the cooling barrel from heating up. The barrel has a reduced diameter section of a given length relative to a larger diameter section of the barrel. The larger diameter section of the barrel is threaded into a first bore in the heat block. A second bore disposed in the heat block is configured to accept the heater cartridge. The temperature sensor is secured to an outside surface of the heat block. The nozzle tip is threaded into the first bore in the heat block adjacent the barrel.

A three-dimensional filament is received in the barrel, is heated to a low viscosity liquid state and while in the low viscosity liquid state is dispensed through the nozzle tip to build a three-dimensional structure. Traditional three-dimensional printer nozzles may not provide adequate differentiation between the larger diameter section of the barrel at the heating block and the cooling barrel portion. If the material cools too rapidly near the heating block material jams may occur at a transition between the heating block and the cooling barrel portion, which require disassembly of the equipment for cleanout, and therefore lost production time.

Thus, while the current nozzles and methods for producing material extrusion three-dimensional printed materials are useful for their intended purpose, there is room in the art for an improved nozzle and method for producing material extrusion three-dimensional printed materials.

### SUMMARY

This disclosure describes a nozzle for producing material extrusion three-dimensional printed materials for use on a material extrusion additive manufacturing three-dimensional printer includes a shank which is mechanically connected to a shank barrel. To minimize thermal transfer between the shank and the shank barrel multiple heat breaks are incorporated including providing the shank of a first material and the shank barrel of a second material having different coefficients of thermal transfer, providing a gap between the nozzle and a nozzle frame, and providing mechanical connections that reduce thermal transfer.

According to several aspects the first material and the second material are metal, with the first material of the shank being a titanium material and the second material of the shank barrel being a stainless steel.

According to several aspects a course thread is used to releasably couple the shank to the shank barrel to reduce material-to-material contact between the shank and the shank barrel.

According to several aspects a raised shoulder of the shank separates the shank barrel from a nozzle frame.

According to several aspects the shank barrel includes an extended edge which directly contacts an internal passage shoulder of the third diameter portion of the shank when the shank barrel is threadably coupled to the shank to further minimize contact between the shank barrel and the shank.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a front perspective view of a nozzle for producing material extrusion three-dimensional printed materials according to the principles of the present disclosure;

FIG. 2 is a side elevational view of a shank of the nozzle of FIG. 1;

FIG. 3 is a cross sectional elevational view taken at section 3 of FIG. 2;

FIG. 4 is a side elevational view of a shank barrel of the nozzle of FIG. 1;

FIG. 5 is a cross sectional elevational view taken at section 5 of FIG. 4;

FIG. 6 is a side elevational view of the nozzle of FIG. 1 in an assembly with a nozzle frame;

FIG. 7 is a top plan view of the assembly of FIG. 6;

FIG. 8 is an end elevational view of the assembly of FIG. 7;

FIG. 9 is a front perspective view of a nozzle for producing material extrusion three-dimensional printed materials according to other principles of the present disclosure modified from the nozzle of FIG. 1;

FIG. 10 is cross-sectioned view of another embodiment of the nozzle;

FIG. 11 is an enlarged view of a portion of the shank and the shank barrel of the nozzle shown in FIG. 10;

FIG. 12 is an exploded view of another embodiment of a shank and a nozzle clamp;

FIG. 13 is a front perspective view of the shank and the nozzle clamp shown in FIG. 12;

FIG. 14 is a front rear view of the shank and the nozzle clamp shown in FIG. 12;

FIG. 15 is an elevational perspective view of the shank shown in FIG. 12;

FIG. 16 is an elevational perspective view of an alternative embodiment of the shank shown in FIG. 15;

FIG. 17 is a cross-sectional view of another embodiment of the nozzle including a filament guide; and

FIG. 18 is an enlarged view of a portion of the nozzle shown in FIG. 17 that includes an outlet of the filament guide.

### DETAILED DESCRIPTION

The following description is merely exemplary in nature and is not intended to limit the present disclosure, application, or uses.

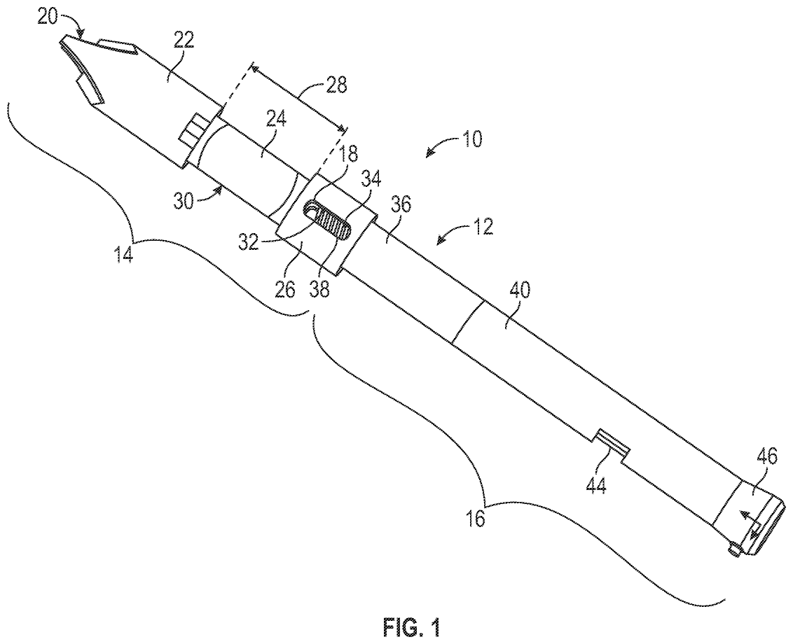

Referring now to FIG. 1, a heated nozzle and method for producing material extrusion three-dimensional printed materials 10 includes a nozzle 12 for use on a material extrusion additive manufacturing (ME-AM) three-dimensional printer. The nozzle 12 includes a shank 14 which is mechanically connected to a shank barrel 16. The shank 14 provides an elongated body with an internal flow passage 18 only partially visible in this view. The shank 14 has a tapered nozzle 20 integral to a first diameter portion 22 opening into the internal flow passage 18, a second diameter portion 24 and a third diameter portion 26. According to several aspects, the first diameter portion 22 has a diameter that is greater than a diameter of the second diameter portion 24. The third diameter portion 26 has a diameter that is greater than the diameter of the second diameter portion 24. Thus, second diameter portion 24 defines a necked down section of the shank 14 having a length 28. The length 28 of the second diameter portion 24 is configured to allow the necked down portion to function as a first “heat break” on an exterior surface 30 of the nozzle 12. A heat break may be understood as a feature, such as the necked down portion of the second diameter portion 24, or further features described below, which reduce a transfer of heat, such as by conduction, along the nozzle 12.

The third diameter portion 26 includes an internally threaded portion 32 to threadably engage with a male threaded portion 34 created on a first shank barrel portion 36 of the shank barrel 16, thereby mechanically coupling the shank 14 to the shank barrel 16. According to several aspects the internally threaded portion 32 and the male threaded portion 34 both define a course thread such as an Acme thread to minimize material-to-material contact between the shank 14 and the shank barrel 16, and thereby define a second heat break for the nozzle 12. An elongated through-bore 38 may also be provided extending through the third diameter portion 26, which exposes a portion of the male threaded portion 34 to atmosphere, thereby defining a third heat break for the nozzle 12.

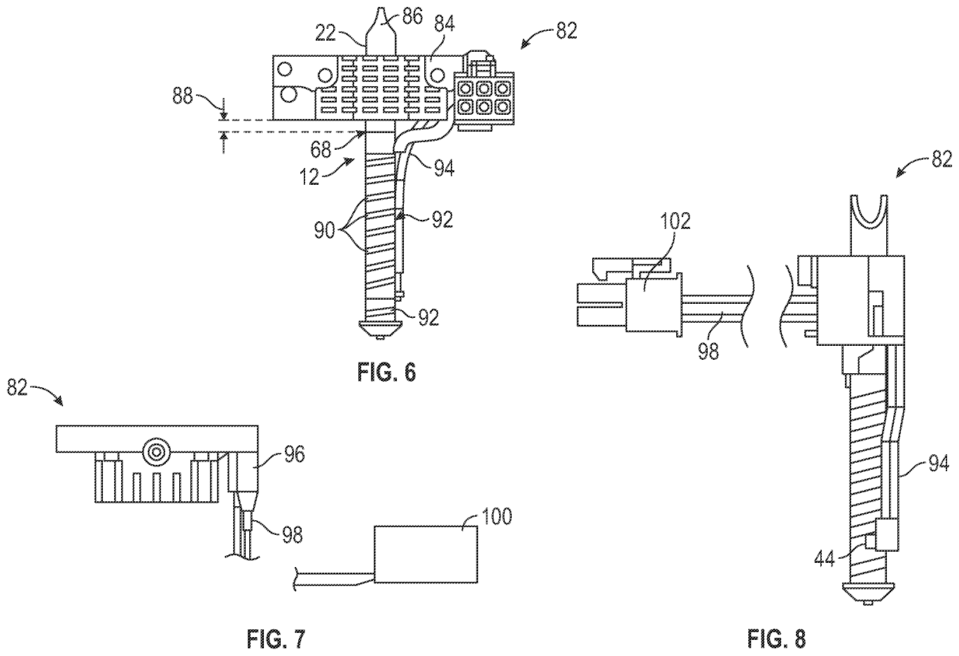

According to several aspects, the first shank barrel portion 36 of the shank barrel 16 is integrally connected to a second shank barrel portion 40 of the shank barrel 16. According to further aspects, the first shank barrel portion 36 of the shank barrel 16 is mechanically connected to the second shank barrel portion 40 of the shank barrel 16, for example by threading. According to several aspects the first shank barrel portion 36 and the second shank barrel portion 40 have a common outside diameter, which provides a common mounting surface for provision of a ceramic sleeve shown and described in reference to FIG. 6. A wiring access port 44 may be provided through the second shank barrel portion 40. An end portion 46 is connected to the second shank barrel portion 40 having a diameter larger than the diameter of the second shank barrel portion 40 to promote retention of the ceramic sleeve.

To further promote a distinct thermal transition between the shank 14 and the shank barrel 16, according to several aspects a material of the shank 14 is selected as a first material different from a material of the shank barrel 16 such that a thermal conductivity of the shank 14 is different from a thermal conductivity of the shank barrel 16. According to several aspects, a material of the shank 14 is a titanium material such as but not limited to a grade 5 titanium, and a material of the shank barrel 16 is a stainless steel such as but not limited to a stainless steel 420 material. Although titanium and stainless steel are discussed, it is to be appreciated that other materials may be used as well. For example, in another embodiment, the shank 14 is constructed of cemented carbides and ceramics, and the shank barrel 16 is constructed of tungsten carbide. Furthermore, as explained below, in embodiments the shank 14 and the shank barrel 16 may include coatings as well. The difference in material and the resulting difference between the thermal conductivity of the shank 14 and the thermal conductivity of the shank barrel 16 defines a fourth heat break for the nozzle 12.

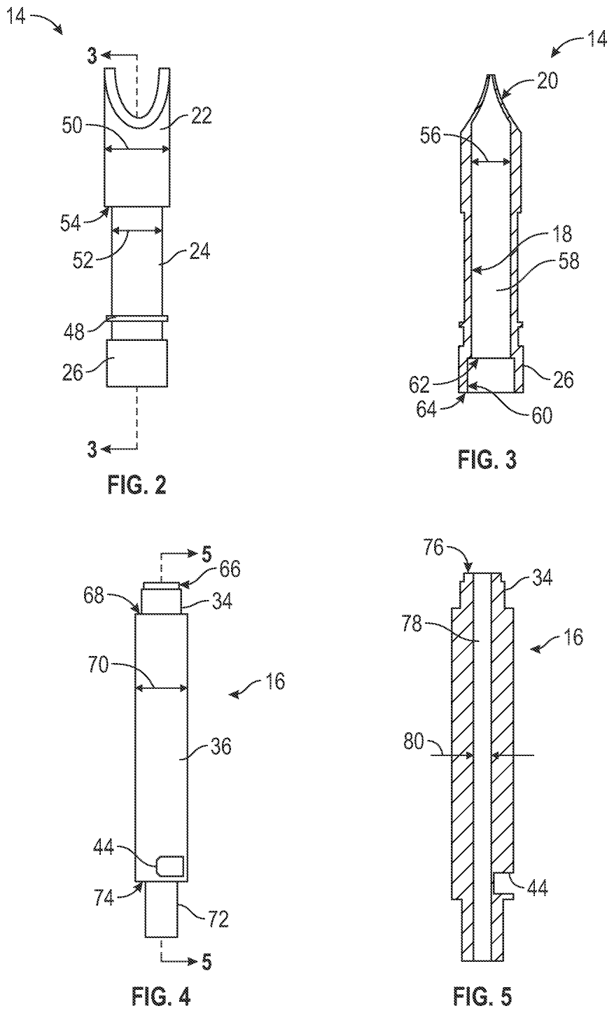

Referring to FIG. 2 and again to FIG. 1, the shank 14 may further include a disc-shaped raised shoulder 48 integrally connected to and extending outwardly from the exterior surface 30 of the second diameter portion 24 of the shank 14. The raised shoulder 48 provides a positive contact surface between the nozzle 12 and a nozzle frame shown and described in greater detail in reference to FIG. 6 which spaces the nozzle frame from 26 thereby reducing heat transfer between the nozzle 12 to the nozzle frame. As previously noted the first diameter portion 22 has a diameter 50 that is greater than a diameter 52 of the second diameter portion 24. A shoulder face 54 formed at a junction between the first diameter portion 22 and the second diameter portion 24 may be seated in a similarly dimensionally shaped recess formed in the nozzle frame.

Referring to FIG. 3 and again to FIGS. 1 through 2, an internal diameter 56 of the shank 14 forms a first portion 58 of the internal flow passage 18. The third diameter portion 26 of the shank 14 includes an internal threaded portion 60 extending to an internal passage shoulder 62. A substantially flat end face 64 is machined or formed at an end of the third diameter portion 26 of the shank 14.

Referring to FIG. 4 and again to FIG. 3, according to an exemplary aspect the shank barrel 16 is shown as a single piece member. The male threaded portion 34 is created on a first stud portion 66 of the first shank barrel portion 36 of the shank barrel 16. The male threaded portion 34 threadably couples to the internal threaded portion 60 of the shank 14 described in reference to FIG. 3. A first standoff shoulder 68 is created between the first stud portion 66 and the first shank barrel portion 36 which is located to allow the first standoff shoulder 68 to be spaced apart from the flat end face 64 of the third diameter portion 26 when the male threaded portion 34 is threadably coupled to the internal threaded portion 60. This spacing provides a further thermal disconnect to minimize heat transfer between the shank 14 and the shank barrel 16. According to several aspects, an outside diameter 70 of the first shank barrel portion 36 may be equal to the diameter 52 of the second diameter portion 24. A second stud portion 72 is also provided on the first shank barrel portion 36 of the shank barrel 16 at an opposite end of the first shank barrel portion 36 with respect to the first stud portion 66. A second standoff shoulder 74 is created between the second stud portion 72 and the first shank barrel portion 36 which allows for mounting of the end portion 46 described in reference to FIG. 1.

Referring to FIG. 5 and again to FIG. 3, the shank barrel 16 further includes an extended edge 76 which directly contacts the internal passage shoulder 62 of the third diameter portion 26 when the shank barrel 16 is threadably coupled to the shank 14 to further minimize contact between the shank barrel 16 and the shank 14, reducing heat transfer between the shank barrel 16 and the shank 14. A through bore 78 of the shank barrel 16 forms a second portion of the internal flow passage 18. The through bore 78 has a bore diameter 80 which is smaller than the internal diameter 56 of the first portion 58 of the internal flow passage 18 extending through the shank 14.

Referring to FIG. 6 and again to FIGS. 1 through 5, an assembly 82 is created by joining the nozzle 12 to a nozzle frame 84. A portion of the first diameter portion 22 extends beyond a surface 86 of the nozzle frame 84 allowing dispersion of heated and liquified material from the nozzle 12. As previously described, to minimize heat transfer between the nozzle 12 and the nozzle frame 84, a fifth heat break is defined by the nozzle frame 84 directly contacting the raised shoulder 48 of the shank 14 (shown and described in reference to FIG. 2), creating a clearance gap 88 between the first standoff shoulder 68 and the nozzle frame 84. A set of heating coils 90 are wrapped about a ceramic barrel 92 which surrounds the shank barrel 16. A set of heating coil wires 94 extends from the nozzle frame 84 and are connected to the heating coils 90. When energized by a current passed by the heating coil wires 94 the heating coils 90 liquefy the filament being fed through the nozzle 12.

Referring to FIG. 7 and again to FIG. 6, a connector 96 is attached to the nozzle frame 84. A wiring harness 98 is connected to the connector 96 and leads to a controller 100. According to several aspects, the controller 100 provides operational control signals to the assembly 82 for operation of the nozzle 12, including the current passed to the heating coils 90. According to several aspects the functionality of printing three-dimensional objects is incorporated into computer software contained in the controller 100.

Referring to FIG. 8 and again to FIGS. 6 through 7, at least a portion of the set of heating coil wires 94 may pass into the wiring access port 44 created in the shank barrel 16, which is shown and described in reference to FIG. 4. A release connector 102 may be provided at an end of the wiring harness 98 to provide releasable connection of the assembly 82.

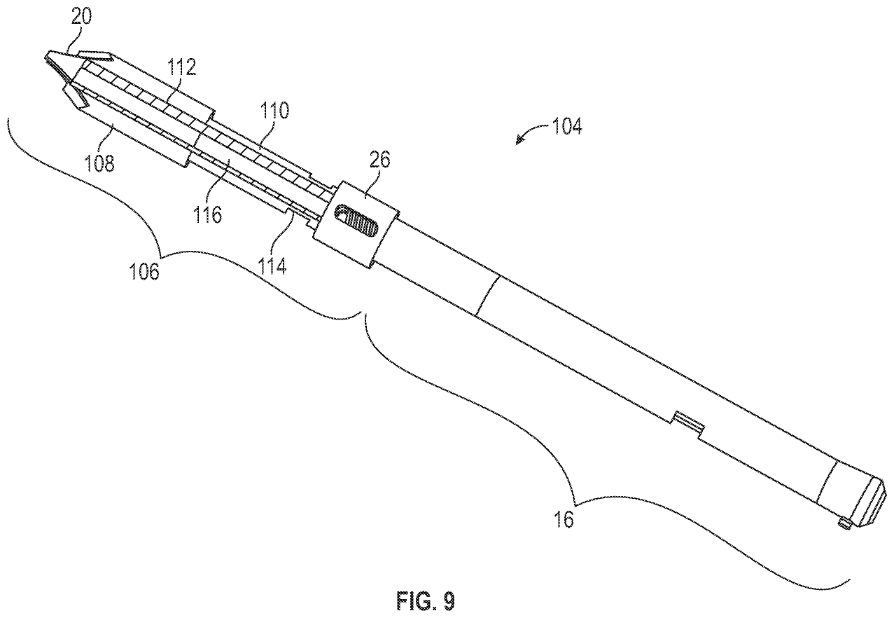

Referring to FIG. 9 and again to FIGS. 1-8, a nozzle 104 is modified from the nozzle 12, with common items having common numbering. The nozzle 104 includes a shank 106 which is mechanically connected to the shank barrel 16. According to several aspects a material of the shank 106 is similar to the material of the shank 14, and therefore may be of a titanium material. The shank 106 provides the tapered nozzle 20 integral to a first diameter portion 108 opening, a second diameter portion 110 connected to the third diameter portion 26. The shank 106 defines an elongated body having a sleeve 112 of a polymeric material such as but not limited to a polytetrafluoroethylene (PTFE) material with an internal flow passage 116 through which the heated filament material displaces toward the tapered nozzle 20. According to several aspects a diameter of the shank 106 may be larger than the diameter of the shank 14 to accommodate the additional material of the sleeve 112. The sleeve 112 being provided of the polymeric material different from the material of the shank 106 also minimizes friction and heat transfer during passage of the filament material through the shank 106. In addition to the sleeve 112, one or more windows 114 may also be provided through a wall of the shank 106 which promote air flow for cooling the transition area between the shank 106 and the shank barrel 16. To further enhance the effect of the windows 114, a positive source of cooling flow from a coolant system such as an air flow or a water flow may be directed at the windows 114 to provide additional heat transfer and positive cooling of the shank 106.

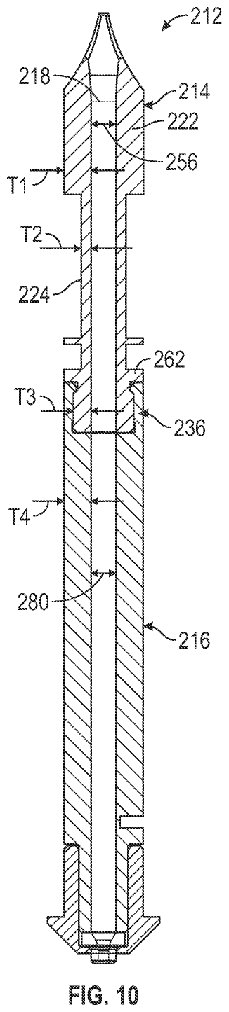

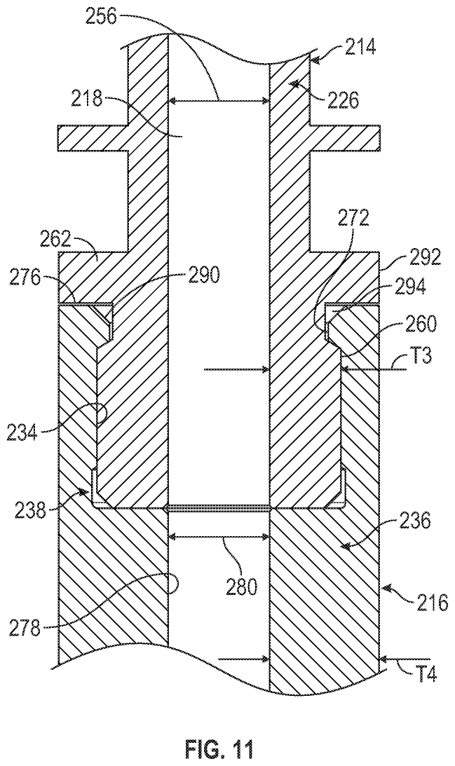

FIG. 10 illustrates an alternative embodiment of a nozzle 212 including a shank 214 threadingly engaged with a shank barrel 216. FIG. 11 is an enlarged view of the shank 214 and the shank barrel 216 located at a third diameter portion 226 of the shank 214. Referring specifically to FIG. 11, the third diameter portion 226 of the shank 214 includes an internal threaded portion 260. The shank barrel 216 includes a first shank barrel portion 236, where a male threaded portion 234 is disposed around an internal diameter 238 located at the first shank barrel portion 236 of the shank barrel 216. The internal threaded portion 260 of the shank 214 is threadingly engaged with the male threaded portion 234 of the first shank barrel portion 236 of the shank barrel 216, thereby mechanically coupling the shank 214 to the shank barrel 216. In the embodiment as shown in FIG. 11, an end surface 276 of the shank barrel 216 directly contacts a shoulder 262 disposed at the third diameter portion 226 of the shank 214 when the shank barrel 216 is mechanically coupled to the shank 214. The end surface 276 includes a chamfered edge 290 disposed around an inner opening 272 of the shank barrel 216. The chamfered edge 290 of the shank barrel 216 and an outer surface 292 of the third diameter portion 226 of the shank 214 cooperate with one another to create a gap or cavity 294 disposed between the shank 214 and the shank barrel 216. The cavity 294 minimizes or reduces the heat transfer between the shank 214 and the shank barrel 216 to define a sixth heat break.

Referring to FIGS. 10 and 11, in the embodiment as shown, the shank 214 includes an internal diameter 256. The internal diameter 256 of the shank 214 forms a first portion of an internal flow passage 218 of the nozzle 212. A through bore 278 of the shank barrel 216 defines a second portion of the internal flow passage 218 of the nozzle 212. The through bore 278 of the shank barrel 216 includes a bore diameter 280. In the embodiment as shown in FIGS. 10 and 11, the bore diameter 280 of the shank barrel 216 is equal to the internal diameter 256 of the shank 214. Furthermore, the shank 214 includes a first wall thickness T1 disposed at a first diameter portion 222 (seen in FIG. 10), a second wall thickness T2 disposed at a second diameter portion 224, and a third wall thickness T3 disposed at the third diameter portion 266 around the internal threaded portion 260 of the shank 214. The first wall thickness T1 is greater than the second wall thickness T2 and the third wall thickness T3 of the shank 214. The shank barrel 216 includes a fourth wall thickness T4 that is greater than the second wall thickness T2 and the third wall thickness T3 of the shank 214. In embodiments, the fourth wall thickness T4 of the shank barrel 216 is equal to the first wall thickness T1 of the shank 214.

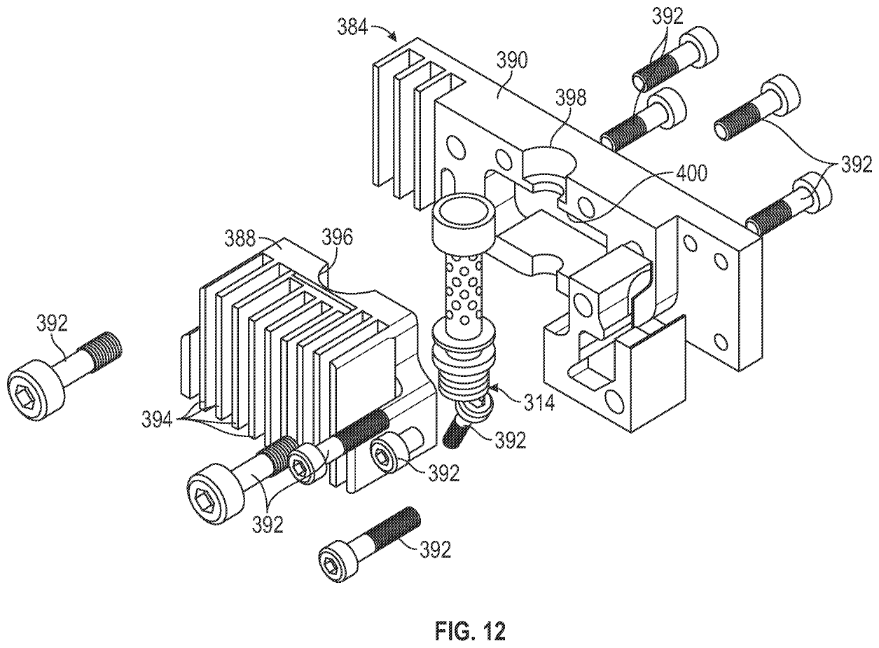

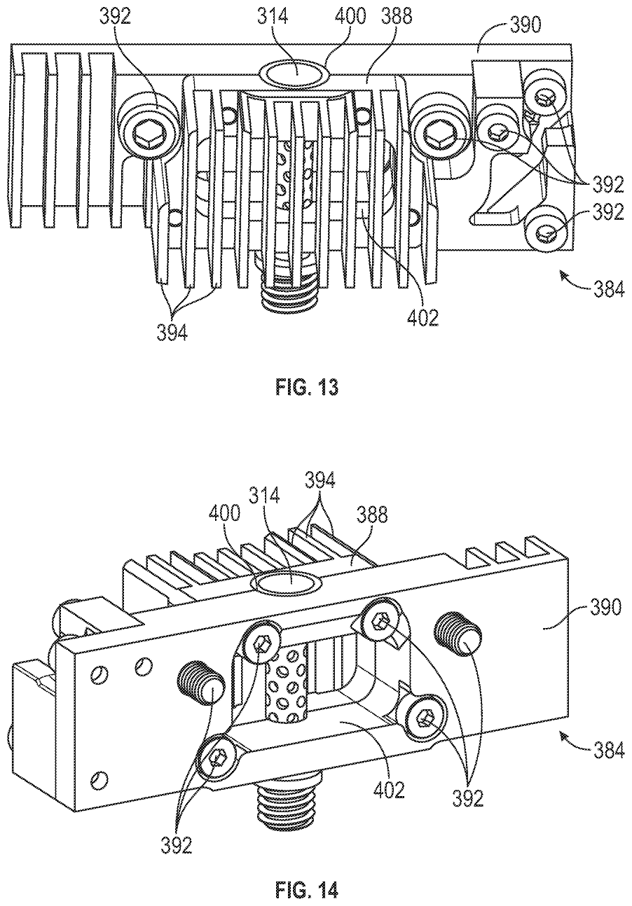

FIGS. 12, 13, and 14 illustrate another embodiment of a shank 314 secured by a nozzle clamping frame 384. The nozzle clamping frame 384 includes a first section 388 and a second section 390, where the first and second sections 388, 390 of the nozzle clamping frame 384 cooperate together to secure the shank 314 in place. Specifically, FIG. 11 is an exploded view of the shank 314, the first section 388 of the nozzle clamping frame 384, the second section 390 of the nozzle clamping frame 384, and a plurality of mechanical fasteners 392. The mechanical fasteners 392 secure the first section 388 of the nozzle clamping frame 384 to the second section 390 of the nozzle clamping frame 384. The first section 388 of the nozzle clamping frame 384 includes a plurality of fins 394 for dissipating heat and a first cavity 396. The second section 390 of the nozzle clamping frame 384 includes a second cavity 398. Referring to FIGS. 12, 13, and 14, the first cavity 396 and the second cavity 398 cooperate with one another to create a rounded or circular cavity 400 that is shaped to receive and secure the shank 314 in place.

Referring specifically to FIG. 14, the second section 390 of the nozzle clamping frame 384 further includes an aperture 402. In embodiments, a fan (not shown) may be mounted adjacent to the aperture 402 within the second section 390 of the nozzle clamping frame 384 to create a flow of cooling air for cooling the shank 314. However, it is to be appreciated that in some embodiments, the fan may be omitted.

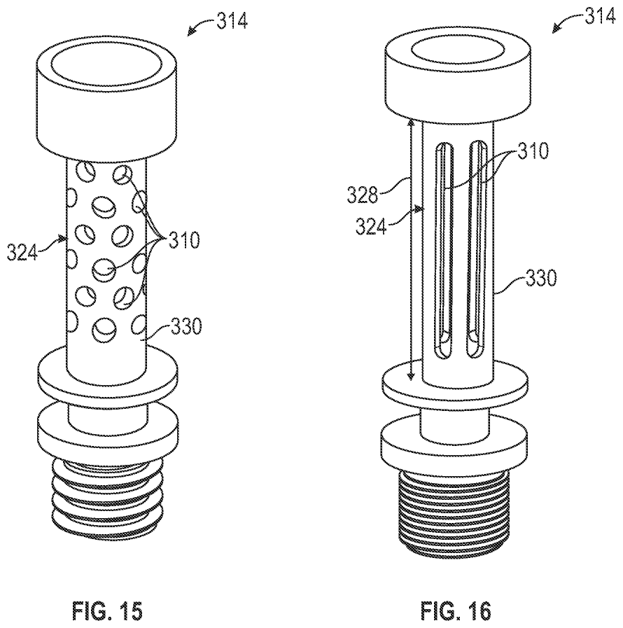

FIG. 15 is an enlarged view of the shank 314 shown in FIGS. 12, 13, and 14. The necked down section of the shank 314 includes one or more openings 310 disposed along a second diameter portion 324 of the shank 314. In the non-limiting embodiment as shown in FIG. 15, the openings 310 are illustrated as round holes, however, it is to be appreciated that FIG. 15 is merely exemplary in nature and the openings 310 may include various sizes and shapes. For example, in the embodiment as shown in FIG. 16, the openings 310 are illustrated as vertically oriented slots that extend along the length 328 of the second diameter portion 324. The openings 310 of the shank 314 reduce heat transfer on an exterior surface 330 of the shank 314.

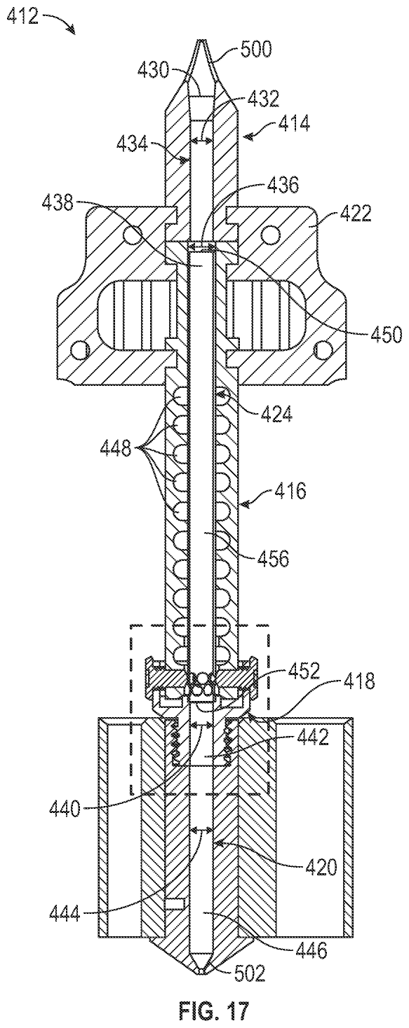

FIG. 17 is a cross-sectioned view of another embodiment of a nozzle 412 including a shank 414, a shank barrel 416, a connector 418, a barrel tip 420, a nozzle frame 422, and a filament guide 424. The shank 414 defines an inlet end 500 and the barrel tip 420 defines a discharge end 502. Extrusion material may enter the nozzle 412 from the inlet end 500 of the shank 414 and exits the nozzle 412 from the discharge end 502 of the barrel tip 420. The shank 414, the shank barrel 416, the connector 418, and the barrel tip 420 cooperate together to define an internal flow passage 430 that extends from the inlet end 500 to the discharge end 502 of the nozzle 412. Extrusion material may enter the internal flow passage 430 from the inlet end 500 and exits from the internal flow passage 430 from the discharge end 502 of the nozzle 412. As explained below, the filament guide 424 is disposed within the internal flow passage 430 of the nozzle 412.

A first internal diameter 432 of the shank 414 defines a first portion 434 of the internal flow passage 430 of the nozzle 412, a second internal diameter 436 of the shank barrel 416 defines a second portion 438 of the internal flow passage 430 of the nozzle 412, a third internal diameter 440 of the connector 418 defines a third portion 442 of the internal flow passage 430 of the nozzle 412, and a fourth internal diameter 444 of the barrel tip 420 defines a fourth portion 446 of the internal flow passage 430 of the nozzle 412. In the embodiment as shown, the first internal diameter 432 of the shank 414 the second internal diameter 436 of the shank barrel 416, the third internal diameter 440 of the connector 418, and the fourth internal diameter 444 of the barrel tip 420 are equal.

The shank barrel 416 includes a plurality of cutouts 448 that are disposed lengthwise along a portion of the shank barrel 416. The cutouts 448 are configured to direct cooling air to the filament guide 424 and also function as heat sinks. In the example as shown in FIG. 17, the filament guide 424 is disposed within the second portion 438 of the internal flow passage 430 of the nozzle 412, within the shank barrel 416. The filament guide 424 includes an inlet 450, an outlet 452, and a passageway 456 that extends between the inlet 450 and the outlet 452. The filament guide 424 is constructed of materials such as, but not limited to, stainless steel and titanium. The filament guide 424 includes a relatively thin wall thickness. Specifically, in an embodiment, the wall thickness of the filament guide 424 ranges from about 0.1 to about 0.35 millimeters. In embodiments, the shank 414 and the filament guide 424 are both coated with PTFE coating, which acts as insulator. Moreover, PTFE has low-friction coefficient which enhances material flow. In embodiments, the barrel tip 420 is coated with nickel, tungsten disulphide (WS₂), or molybdenum disulphide (MoS₂).

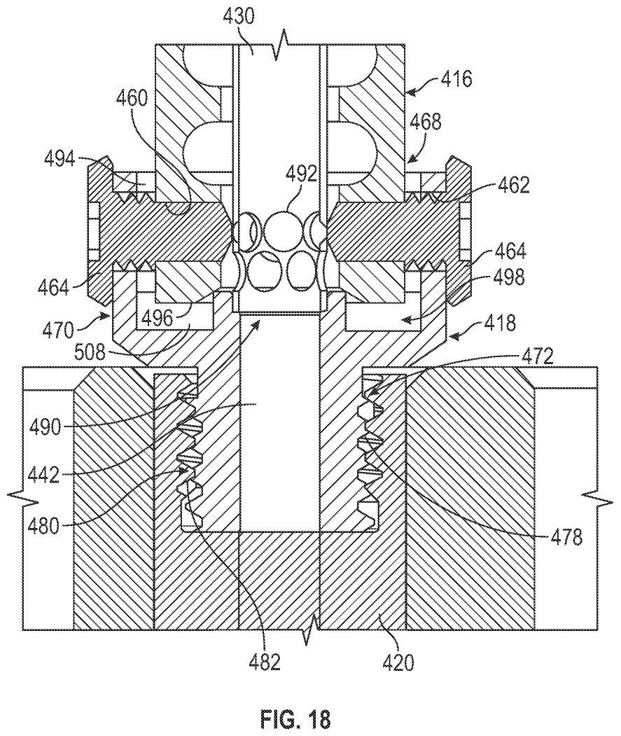

FIG. 18 is an enlarged view of a portion of the shank barrel 416, the connector 418, and a portion of the barrel tip 420. As seen in FIG. 18, the shank barrel 416 and the connector 418 both include corresponding apertures 460, 462 that are shaped to receive a pair of mechanical fasteners 464. In the embodiment as shown in FIG. 18, the fasteners 464 are threaded screws. The mechanical fasteners 464 secure the connector 418 to a distal end 468 of the shank barrel 416. Although FIGS. 17 and 18 illustrate mechanical fasteners 464, other joining approaches may be used as well such as, for example, pin joints, threading between the shank barrel 416 and the connector 418, press fit with swaging, or welding.

The connector 418 includes a first diameter portion 470 and a second diameter portion 472, where the second diameter portion 472 of the connector 418 includes a plurality of threads 478. The second diameter portion 472 of the connector 418 is received by an opening 480 of the barrel tip 420. Specifically, in the embodiment as shown, the opening 480 of the barrel tip 420 includes a plurality of threads 482 that threadingly engage with the threads 478 of the connector 418, thereby mechanically coupling the connector 418 with the barrel tip 420. Although FIGS. 17 and 18 illustrate a connector 418, in embodiments the connector 418 may be omitted, and instead the shank barrel 416 is directly coupled to the barrel tip 420.

The filament guide 424 defines a distal end 490 that extends into the third portion 442 of the internal flow passage 430 within the connector 418. In the embodiment as shown, a plurality of openings 492 are disposed at the distal end 490 of the filament guide 424. The plurality of openings 492 disposed at the distal end 490 of the filament guide 424 serve as a heat break, while at the same time maintaining structural rigidity. Although the shank barrel 416 and the filament guide 424 are described as separate parts, in embodiments the shank barrel 416 and the filament guide 424 may be an integral part. Furthermore, in embodiments, the barrel tip 420 may also include a separate barrel and tip as well.

Continuing to refer to FIG. 18, an insulator 494 is disposed around the distal end 468 of the shank barrel 416. The insulator 494 is configured to reduce the flow of heat. In embodiments, the insulator may also be air. Furthermore, an end surface 496 located along the distal end 468 of the shank barrel 416 and an annular opening 498 disposed within the connector 418 cooperate with one another to define an empty space or cavity 508. The cavity 508 disposed within the connector 418 is filled with air, and acts as an insulator to further reduce the flow of heat.

During operation of the nozzle 12 common print parameters may be adjusted. For example a print speed may be adjusted to maintain a constant polymer extrusion speed or to change the extrusion speed. A constant extrusion speed allows the extrusion material to have the same residence time in the nozzle 12 and have approximately the same deposition temperature, reducing a likelihood of heat transfer causing a blockage of the extrusion material within the nozzle 12.

The present disclosure provides a nozzle 12 for receiving, heating and dispensing a three-dimensional filament to progressively build a three-dimensional structure. The three-dimensional filament may be an elongated tubular member made of various polymeric or non-polymeric materials. The nozzle 12 receives the three-dimensional filament, heats the three-dimensional filament to a low viscosity liquid state and dispenses the heated material onto a support platform. A three-dimensional structure is formed by dispensing successive layers of the three-dimensional filament material from the nozzle 12. A variety of different three-dimensional filament materials may be used to build different three-dimensional structures having different structural properties and appearances.

According to further aspects the nozzle 12 includes a shank 14 which is mechanically connected to a shank barrel 16, the shank being a first material and the shank barrel 16 being a second material different from the first material.

According to several aspects the first material and the second material are selected such that a coefficient of thermal transfer of the first material is different from a coefficient of thermal transfer of the second material.

According to several aspects the first material and the second material are metal, with the first material of the shank 14 being a titanium material and the second material of the shank barrel 16 being a stainless steel.

According to several aspects multiple heat breaks are provided to minimize heat transfer between portions of the nozzle 12. The heat breaks include a first heat break defining a length 28 of the second diameter portion 24 configured to allow the necked down portion to reduce heat transfer on an exterior surface 30 of the nozzle 12, a second heat break defining an internally threaded portion 32 and the male threaded portion 34 both defining a course thread to minimize material-to-material contact between the shank 14 and the shank barrel 16, a third heat break defining an elongated through-bore 38 extending through the third diameter portion 26 which exposes a portion of the male threaded portion 34 to atmosphere, a fourth heat break defining the difference in material and the resulting difference between the thermal conductivity of the shank 14 and the thermal conductivity of the shank barrel 16, and a fifth heat break defined when the nozzle frame 84 directly contacts the raised shoulder 48 of the shank 14 (shown and described in reference to FIG. 2) which creates a clearance gap 88 between the first standoff shoulder 68 and the nozzle frame 84.

The description of the present disclosure is merely exemplary in nature and variations that do not depart from the gist of the present disclosure are intended to be within the scope of the present disclosure. Such variations are not to be regarded as a departure from the spirit and scope of the present disclosure.

1. A nozzle for producing material extrusion in a three-dimensional printer, the nozzle comprising:
a shank including an internal flow passage, wherein the shank is constructed of a first material having a first thermal conductivity; and
a shank barrel mechanically coupled to the shank, wherein the shank barrel is constructed of a second material having a second thermal conductivity, and wherein the first thermal conductivity of the first material is different from the second thermal conductivity of the second material to create a first heat break between the shank and the shank barrel, wherein the first heat break reduces heat transfer between the shank and the shank barrel.

2. The nozzle of claim 1, wherein the shank includes a tapered nozzle integral to a first diameter portion, wherein the first diameter portion opens to the internal flow passage of the shank.

3. The nozzle of claim 2, wherein shank includes a second diameter portion, wherein the first diameter portion of the shank includes a first diameter that is greater than a second diameter of the second diameter portion of the nozzle.

4. The nozzle of claim 3, wherein the second diameter portion of the nozzle includes a necked down section including a length, wherein the necked down section of the shank is configured to function as a second heat break along an exterior surface of the nozzle.

5. The nozzle of claim 4, wherein the necked down section of the nozzle defines one or more openings.

6. The nozzle of claim 5, wherein the one or more openings are slots that extend along the length of the necked down section of the nozzle.

7. The nozzle of claim 3, wherein the nozzle includes a third diameter portion including an internally threaded portion.

8. The nozzle of claim 7, wherein the shank barrel includes a male threaded portion on a first shank barrel portion.

9. The nozzle of claim 8, wherein the internally threaded portion of the shank threadingly engages with the male threaded portion of the shank barrel to mechanically couple the shank and the shank barrel to one another to define a third heat break.

10. The nozzle of claim 9, wherein the internally threaded portion of the shank and the male threaded portion of the shank barrel both include Acme threads.

11. The nozzle of claim 9, wherein the nozzle includes a through-bore extending through the third diameter portion, wherein the through-bore exposes a portion of the male threaded portion of the shank barrel to define a fourth heat break.

12. The nozzle of claim 8, wherein the shank barrel includes a second shank barrel portion mechanically connected to the first shank barrel portion.

13. The nozzle of claim 12, wherein both the first shank barrel portion and the second shank barrel portion include a common outside diameter that defines a common mounting surface.

14. The nozzle of claim 13, further comprising a ceramic barrel located around the common mounting surface.

15. The nozzle of claim 8, wherein the shank includes a raised shoulder that is connected to and extends outwardly from an exterior surface of the second diameter portion of the shank.

16. The nozzle of claim 15, further comprising a nozzle frame joined to the nozzle, wherein the nozzle frame directly contacts the raised shoulder of the raised shoulder to define a fifth heat break.

17. The nozzle of claim 1, wherein the shank includes a sleeve constructed of a polymeric material, and wherein the internal flow passage of the shank is included with the sleeve.

18. The nozzle of claim 1, further comprising a cavity disposed between the shank and the shank barrel, wherein the cavity defines a sixth heat break.

19. The nozzle of claim 1, further comprising a filament guide disposed within a second portion of the internal flow passage defined by the shank barrel.

20. The nozzle of claim 19, wherein the filament guide defines a distal end, and wherein a plurality of openings are disposed at the distal end of the filament guide.
